(19) United States
(12) Patent Application Publication
(10) Pub. No.: US 2004/0216765 A1
(43) Pub. Date: Nov. 4, 2004

(54) Automated chimney cleaning apparatus

(76) Inventor: Henry E. Frenette, Pittsfield, NH (US)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/427,021

(22) Filed: Apr. 30, 2003

(51) Int. Cl. F23J 3/00; B08B 9/04

(52) U.S. Cl. 134/8; 15/249.2; 15/249.3; 15/249.1

(57) ABSTRACT

A chimney cleaning apparatus and method of using the same to clean a chimney. The chimney cleaning apparatus comprises a support structure for attaching the chimney cleaning apparatus adjacent an exhaust outlet of a chimney. An adjustable rotatable arm is supported by the support structure and a drive mechanism rotates the adjustable rotatable arm relative to the support structure. A cable is attached to a free end of the adjustable rotatable arm and the cable, during use, extending into a discharge passage of the chimney to facilitate cleaning of the chimney when the drive mechanism rotates the adjustable rotatable arm.

### FIELD OF THE INVENTION

The present invention relates to an apparatus for automatically cleaning the chimney liner of a chimney.

### BACKGROUND OF THE INVENTION

When wood, coal or some other combustible material is burned, a chemical reaction occurs. As fire consumes the wood, coal or other combustible material, the combustible material is converted into charcoal and gases, such as carbon monoxide, are produced. Creosote, ash and soot, also a direct result of the combustion or burning process, are carried up the chimney with hot air and smoke as these gases exhaust out through the chimney. Over a prolonged period of time of burning wood, coal or other similar combustible materials, creosote, ash and soot will be deposited along and build up on the interior surface of the chimney, also known as the chimney liner.

Water is also released during the chemical reaction that takes place when wood, coal or other combustible material is consumed or burnt by fire. This water, typically in the form of water vapor, is generally carried up along with the hot air and smoke and exhausted out of outlet of the chimney. The creosote, ash and soot that sticks to or builds up on the chimney liner tends to absorb some of this water vapor causing the built up creosote, ash and soot layer to become thicker, heavier, denser and moist. Over time, if the chimney liner is not properly cleaned, the heat from the hot air rising up through the chimney causes a drop in humidity levels of the built up creosote, ash and soot layer which, in turn, causes the layer to turn into a glaze which resembles charcoal. This glazed material which resembles charcoal is highly combustible.

Chimneys need periodical cleaning to remove any buildup of creosote, ash and soot on or along the chimney liner. To prevent or decrease the chance of chimney fires caused by the buildup of this creosote, ash and soot layer, it is highly recommended to remove the buildup of creosote, ash and soot at least once every burning season or more preferably after burning a cord of wood, or when an equivalent amount of coal or some other combustible material has been burnt.

To clean a chimney, typically a chimney sweep will utilize a brush having an outer diameter or circumference which is at least substantially the same size or slightly larger than the inside diameter of the chimney liner. Such a brush is attached to one end of an elongate pole. The chimney sweep will insert the brush into the outlet located at the top of the chimney and lower the brush down the chimney. The chimney sweep will then move the bush vertically up and down along the length of the chimney and manipulate the brush to scrape, brush and/or knock off the layer of creosote, ash and/or soot which has built up along the inwardly facing surface of the chimney liner. The dislodged creosote, ash and soot generally falls from the surface of the chimney liner to a collection area located at the bottom of the chimney. A cleaning opening or port in the chimney allows the chimney sweep to collect and remove the dislodged creosote, ash and/or soot from the chimney once the cleaning process is completed.

Chimney cleaning is typically done during the spring, summer or autumn months when the dangers of walking along a roof, to access the top of the chimney, are not exacerbated by the presence of snow and/or ice. However, cleaning a chimney during the spring, summer and autumn months still present a danger, to the operator of the chimney sweep, of falling off a roof during the manipulation of the cleaning brush and pole while cleaning the chimney.

### SUMMARY OF THE INVENTION

Wherefore, it is an object of the present invention to overcome the above mentioned shortcomings and drawbacks associated with the prior art.

Wherefore, it is an object of the present invention to provide a chimney cleaning apparatus that is effective for clearing the inwardly facing surface(s) of the chimney liner of any built up creosote, ash and/or soot which may accumulate thereon during the burning of wood, coal or some other combustibly material.

A further object of the invention is to provide a chimney cleaning device in which the cleaning is effected simply by rotation of an arm having a cable fixed thereto. The arm, being located at the top of the chimney flue, suspends the cable down the inside length of the chimney and, upon rotation of the arm, the cable comes into contact with the inside surface of the chimney thereby knocking off and removing any and all accumulated creosote, ash and/or soot.

Another object of the invention is to fix a chimney cleaning device to the top of the chimney and provide means for automatic rotation of the arm and cable such that chimney cleaning is automatic and thus reduces the need for chimney maintenance which requires a person to access the chimney from the rooftop.

It is still a further object of the invention to provide an automatic chimney cleaning apparatus which is of simple construction, easy and effective in use and inexpensive to manufacture and assemble.

The present invention relates to a chimney cleaning apparatus comprising a support structure for attaching the chimney cleaning apparatus adjacent an exhaust outlet of a chimney; an adjustable rotatable arm supported by the support structure; a drive mechanism for rotating the adjustable rotatable arm relative to the support structure; and a cable attached to a free end of the adjustable rotatable arm and the cable, during use, extending into a discharge passage of the chimney to facilitate cleaning of the chimney when the drive mechanism rotates the adjustable rotatable arm.

The present invention further relates to a chimney cleaning apparatus comprising a support structure for attaching the chimney cleaning apparatus adjacent an exhaust outlet of a chimney defining a longitudinal axis, and a main shaft is rotatably coupled to the support structure by at least one bearing so that the main shaft is substantially coincident with the longitudinal axis of the chimney; an adjustable rotatable arm supported by a first end of the main shaft; an electric motor attached to a second end of the main shaft for rotating the adjustable rotatable arm relative to the support structure; and a cable attached to a free end of the adjustable rotatable arm and the cable, during use, extending into a discharge passage of the chimney to facilitate cleaning of the chimney when the electric motor rotates the adjustable rotatable arm and the cable.

The present invention also relates to a method of cleaning a chimney with a chimney cleaning apparatus, the method comprising the steps of attaching, via a support structure, the chimney cleaning apparatus adjacent an exhaust outlet of a chimney defining a longitudinal axis, and rotatably coupling a main shaft to the support structure by at least one bearing so that the main shaft is substantially coincident with the longitudinal axis of the chimney; supporting an adjustable rotatable arm at a first end of the main shaft; attaching an electric motor a second end of the main shaft for rotating the adjustable rotatable arm relative to the support structure; and attaching a free end of a cable to the adjustable rotatable arm and extending the free end of the cable into a discharge passage of the chimney, and cleaning of the chimney as the electric motor rotates the adjustable rotatable arm and cable.

### DESCRIPTION OF THE DRAWINGS

The invention will now be described, by way of example, with reference to the accompanying drawings in which

FIG. 1 is a diagrammatic perspective view of a first embodiment of a chimney cleaning apparatus;

FIG. 2 is a diagrammatic sectional view of a second embodiment of the chimney cleaning apparatus with air flow sensors and a CPU;

FIG. 2A is a diagrammatic view of a disengageable drive having a mating pair of electrically powered magnets for selectively coupling a first main shaft to a second main shaft;

FIG. 3 is a diagrammatic perspective view of a third embodiment of the chimney cleaning apparatus with a windmill providing rotational drive;

FIG. 4 is a diagrammatic perspective view of a fourth embodiment of the chimney cleaning apparatus showing an electric motor connected to a power source;

FIG. 5 is a diagrammatic cross sectional view taken generally on line 5-5 of FIG. 1;

FIG. 6 is a diagrammatic top view of the chimney cleaning apparatus of FIG. 1;

FIG. 7 is a diagrammatic view of the free hanging end of the cable having an end cap; and

FIG. 8 is a diagrammatic respective view of swivel bar attached to the free end of the cable.

### DESCRIPTION OF THE PREFERRED EMBODIMENTS

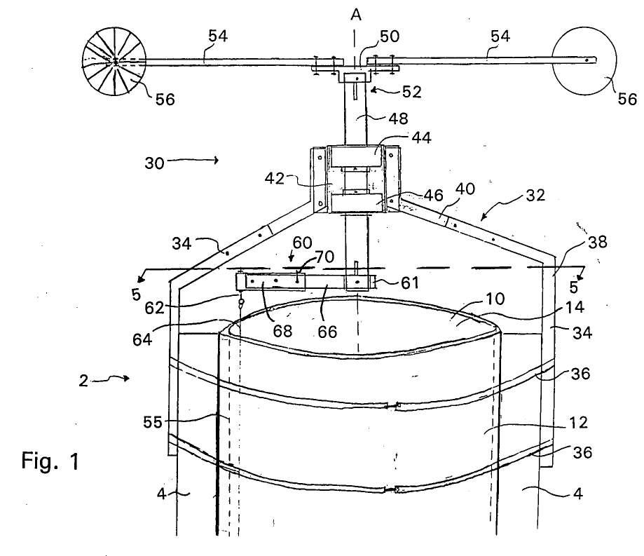

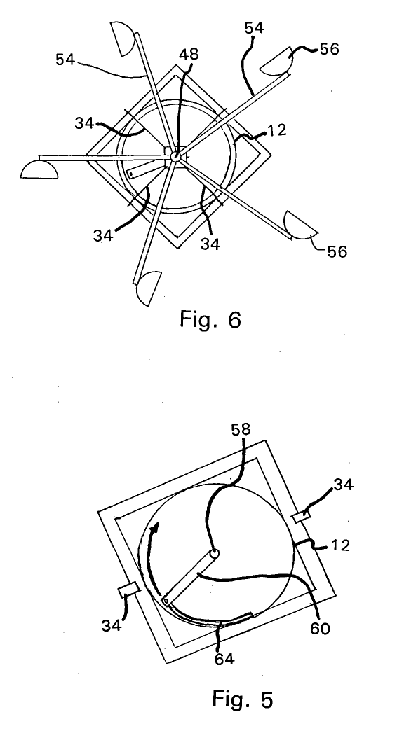

Turning now to FIGS. 1, 2, 5 and 6, a detailed description concerning the basic components of a chimney will first be discussed and this will be followed by a detailed description concerning the present invention. As can be seen in those Figures, the chimney is designated with reference numeral 2 and is generally formed of a plurality of cinder blocks, masonry blocks or bricks 4 which are stacked on top of one another in an customary overlapped configuration and cemented together by a layer of traditional mortar or concrete. The exterior configuration of the chimney 2 generally has a circular, a square or a rectangular shaped transverse cross section and the chimney may be either a single flue or a double flue. The bottom most layer of cinder blocks or bricks 4 rest upon a base pad or some other foundation structure 8 which provides support for the entire chimney 2 and ensures that the chimney 2 remains substantially erect in a vertical orientation at all times. The inwardly facing surface of the bricks 4, defining each: flue 10 of the chimney 2, is typically lined with a ceramic chimney liner 12 which is better able to withstand the high temperature of the gases being exhausted via the flue during the burning process, until they are discharged from the chimney.

An upper most top portion of the chimney defines an exhaust outlet 14 of the chimney 2 while a vertically lower portion of the chimney includes at least one exhaust port or opening 16 for each flue 10 which communicates with an interior space of the house, cabin, building or some other structure requiring the venting provided by the chimney 2. Typically, an exhaust duct 18 of a wood or coal stove burner, or other heating apparatus 20 is connected to this exhaust port 16 to transfer the exhaust gases, emissions and/or debris from the wood or coal stove 20 to the chimney 2. Each flue 10 of the chimney 2 defines a vertical discharge passage 22 which extends from the exhaust port 16 to the chimney exhaust outlet 14 to facilitate conveying the exhaust gases, emissions and/or debris created by combustion of the wood, coal or other fuel within the wood or coal stove, burner, or other heating apparatus 20. A cleaning port 26 is also typically provided in the vertically lower portion of the chimney 2, generally at a position vertically lower than the exhaust port 16, to facilitate periodic cleaning of any debris, soot, partially consumed fuel, etc., which falls or settles adjacent the base of the flue 10 of the chimney 2.

The chimney cleaning apparatus 30, according to the present invention, is supported above or adjacent the upper top most portion of the chimney 2 by a framework or some other support structure 32. The support structure 32 typically comprises four legs 34, for example. Each leg 34 is secured to the top most portion of the chimney 2 by at least one strap or clamping element 36 or some other securing device. According to this embodiment, each leg 34 is maintained in abutting relationship with an exterior surface of the chimney 2 by the at least one clamping element 36 which circumscribes the entire circumference of the chimney 2 in order to fixedly support the chimney cleaning apparatus 30 to the chimney 2. It is to be appreciated that there are a variety of other ways for attaching or installing the chimney cleaning apparatus 30 to the top most region or portion of the chimney 2 and such other securement variations would be readily apparent to those skilled in the art and are all considered to be within the spirit and scope of the present invention. It is to be appreciated that only three legs, or possible one or two legs 34 may be utilized for attaching or installing the chimney cleaning apparatus 30 to the chimney and/or such legs may be permanently attached to the chimney by masonry screws, cement, mortar, brackets, bolts, clamps, etc.

Each leg 34 comprises both a vertical segment 38 and a radially extending segment 40. Each one of the radially extending segments 40 extends generally radially inward toward a central longitudinal axis A of the chimney 2 at a location between about 3 and 6 inches, preferably about 8 inches, above the exhaust outlet 14 of the chimney 2. The radially inward most region of each radially extending segment 40 is connected to and supports a bearing housing 42 in a manner such that a central axis of the bearing housing 42 is aligned and substantially coincident with the longitudinal axis A of the chimney 2. The bearing housing 42 supports a pair of spaced apart bearings, namely, an upper first bearing 44 and a lower second bearing 46. An outer face of the first bearing 44 and an outer face of the second bearing 46 are both supported by the bearing housing 42 while an inner face of the first bearing 44 and an inner face of the second bearing 46 are both connected to an intermediate area of a main rotational shaft 48. Due to this arrangement, the main shaft 48 is located in a vertical orientation such that a longitudinal axis of the main shaft 48 is also aligned and coincident with the longitudinal axis A of the chimneys.

A first bracket 50 is securely affixed to the vertically top most second end 52 of the main shaft 48, which is remote from the exhaust outlet 14 of the chimney 2. A first end of a plurality of radially extending shafts 54 are permanently connected to the bracket 50 while an opposed free end of each one of the radial shafts 54 is connected to a wind cup 56. Each of the plurality of radial shafts extends radially outward substantially perpendicular to the longitudinal axis A of the chimney. The radial shafts 54 are fixed to the bracket 50 and the respective wind cup 56 by screws, bolts or any other conventional fastening arrangement or device. Each radial shaft 54 has a length between 12 and 24 inches, more preferably each radial shaft 54 has a length between 12 and 24 inches.

Each wind cup 56 is sufficiently curved to ensure capturing an adequate quantity of wind and generally has a diameter between 8 and 12 inches, more preferably each wind cup 56 generally has a diameter between 10 and 12 inches. As can be seen in FIG. 6, five radial shafts 54 are fixed to the bracket 50 and each radial shaft 54 supports a respective wind cup 56. With this configuration, as the wind blows, the wind will be captured by the inwardly curved surfaces of the wind cups 56, e.g., the wind cups function as sails. The wind induces a force on the wind cups 56 in the same direction that the wind is blowing. This induced motion is conveyed along the respective radial shafts 54 and transferred to the main shaft 48 causing it to rotate in a desired direction, e.g., either in a clockwise or a counter clockwise direction. The rear surface of the wind cup 56 is designed to cut or slice through the wind without producing excessive drag so as to avoid significantly hindering rotation of the main shaft 48. It is to be appreciated that the number of radial shaft wind cups may vary depending upon a number of factors, e.g., the sized of the chimney cleaning apparatus 2, the width of the flue to be cleaned, the length of the suspended chain, etc.

A lower first end of the main shaft 48, which is adjacent the exhaust outlet 14 of the chimney 2, supports a radially outwardly extending adjustable arm 60. A first end of the adjustable arm 60 is fixedly secured to the main shaft 48, e.g., by a second bracket 61 and mating bolts and nuts (not numbered), for example, while a second opposed end of the adjustable arm 60 supports a hanging device 62, such as an eye hook, which facilitates suspension of a cleaning cable 64. Preferably, the adjustable arm 60 extends generally normal to the main shaft 48 and the longitudinal axis A of the chimney 2. The adjustable arm 60 may comprise first and second telescoping arm sections 66, 68, e.g., the first arm section 66 is partially received within the second arm section 68 to shorten the radially length of the adjustable arm 60 and also allows extracting of the first arm section 66 from the second arm section 68 to increase the total length of the adjustable arm 60. A pin, or some other conventional and well known fastening member 70 may be utilized for securing the first and second arm sections 66, 68 in their adjusted position. Adjustment of the adjustable arm 60 allows the chimney cleaning apparatus 2 to accommodate cleaning of different size flues 10 with relative ease. The adjustable arm 60 typically is able to adjust from a minimum length of about 3 inches to a maximum length of about 6 inches, more preferably the adjustable arm 60 typically is able to adjust from a minimum length of about 3 inches to a maximum length of about 6 inches. The adjustable arm 60 is typically adjusted such that the hanging device is position between about 3 inches and 6 inches, more preferably about ⅛ of an inch from the inwardly facing surface of the flue to be cleaned.

A first end of the cleaning chain, member or cable 64 is connected to the hanging device 62 while a second opposed free end of the cable 64 extends substantially vertically downward into the discharge passage of the chimney 2. The cable 64 has a length of between about 10 feet to about 50+ feet, more preferably cable 64 has a length of between about 10 feet to about 50+feet. The length of the cable 64 is dependent on the height of the chimney 2 and the length of flue 10 desired to be kept clean. Any gage cable may be used with the chimney cleaning apparatus 2, however, it is preferable to use a cable having an 1/8 inch diameter. It is also possible to use a length of chain instead of the cable. When the chimney cleaning apparatus 30 is installed over a chimney 2, the adjustable arm section 68 should be adjusted and secured to the fixed arm section 66 such that the cable 64 hangs parallel to the inwardly facing surface of the chimney liner 12.

Once the chimney cleaning apparatus 30 in place over the exhaust outlet 14 of the flue 10 to be cleaned, the chimney cleaning apparatus 30 is then ready for use. As briefly described above, as the wind cups 56 catch the wind, the wind cups 56 exert a rotational force on the radial shafts 54, the bracket 50 and the main shaft 48 causing them to rotate in a desired direction, e.g., rotate in a clockwise direction about the longitudinal axis A. As the main shaft 48 rotates, the adjustable arm 60 also rotates therewith and this causes the cable 64, suspended by the hanging device 62, to commence rotation and follow the adjustable arm 60 about its circular rotational path or orbit which is substantially concentric with the longitudinal axis A. As the cable 64 rotates within the discharge passage 22 of the flue 10 of the chimney 2, the cable 64 swings or is forced radially outward away from the longitudinal axis A of the chimney 2 due to centrifugal force. This radially outward movement of the cable 64 causes the cable 64 to abut against the inwardly facing surface of the flue 10. As the cable 64 is being rotated, the cable 64 scrapes or rubs against the inwardly facing surface of the flue 10. This scraping or rubbing contact, between the cable 64 and the inwardly facing surface of the flue 10, causes any creosote, ash, soot and/or other debris which may have adhered to the inwardly facing surface of the flue, to be dislodged or loosened therefrom. Such dislodged creosote, ash, soot and/or other debris (such as combustion byproducts) falls, due to gravity, and settle and collect at the bottom of the flue 10 of the chimney 2. The collected creosote, ash, soot and/or other debris can then be periodically removed from the chimney 2 during a conventional cleaning process by accessing the cleaning port 26 when desired, e.g., once a year.

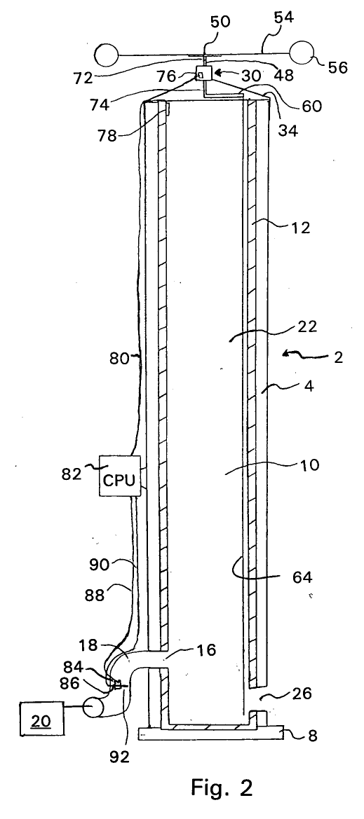

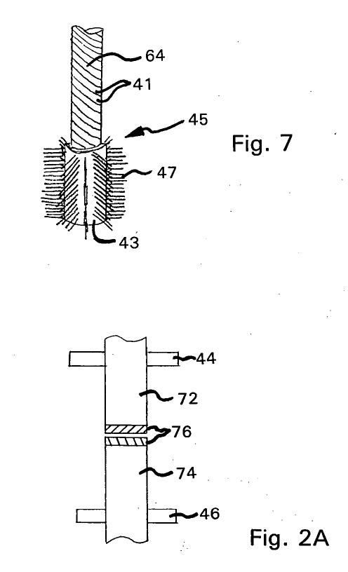

With specific reference now to FIGS. 2 and 2A, a second embodiment of the chimney cleaning apparatus will now be described. As this embodiment is quite similar to the first embodiment in many respects, like reference numerals are utilized for like elements and a detailed discussion will only be provided with respect to the differences between the second embodiment versus the first embodiment.

According to this embodiment, the main shaft 48, for example, is formed as aligned first and second main shafts 72, 74 and a disengageable drive 76 interconnects the first and second main shafts 72, 74 with one another. When the disengageable drive 76 is engaged, the first and second main shafts 72, 74 are coupled to one another and rotate simultaneously with one another. When the disengageable drive 76 is disengaged, the first and second main shafts 72, 74 are uncoupled from one another so that the first main shaft 72 is able to rotate with the radial shafts 54 and wind cups 56 relative to the second main shaft 74 and a remainder of the chimney cleaning apparatus 30. The chimney cleaning apparatus 30 further includes a velocity probe 78 which is positioned at or adjacent the exhaust outlet 14 of the flue 10 to measure the velocity of the exhaust gases as the gases exit therefrom. Electrical wire(s) 80 electrically couple the velocity probe 78 to a central processing unit (CPU) 82. The velocity probe 78 detects a speed of the gases exiting from the chimney 2 and sends a signal, indicative of that measurement to the CPU 82 for processing. A temperature probe 84 and a damper position sensor 86 are also electrically coupled to the CPU 82 by further electrical wire(s) 88, 90. The temperature probe 84 and the damper position sensor 86 are both located within the exhaust duct 18 of the wood or coal stove 20. The temperature probe 84 measures the temperature of the gases exiting from the wood or coal stove 20 and flowing along the exhaust duct 18 while the damper position sensor 86 determines the position of the damper 92, e.g., is the damper 92 completely opened or closed or is it at some intermediate position. Both of these measurements are sent to the CPU 82 for processing.

Due to this arrangement, the disengageable drive 76 is normally disengaged so that the first and second shafts 72, 74 are uncoupled from one another and the first shaft 72 is able to rotate relative to the second main shaft 74. This remains the case as long as an adequate exhaust gas flow is measured by the velocity probe 78. When a significant drop in the velocity of the exhaust gases is detected—this condition is indicative that debris is building up within the flue—the disengageable drive 76 is engaged so that the first and second main shafts 72, 74 are coupled to one another and rotate simultaneously with one another. Rotation of the main shaft facilitates cleaning of the flue as discussed above. Once the flue 10 is adequately cleaned, this will typically restore the velocity of the exhaust gases back to a normal range and the disengageable drive 76 can then be disengaged.

The CPU 82 may be programmed to prevent engagement of the disengageable drive 76 if the temperature probe 84 senses a too low a temperature, possibly indicating that the stove is off and not operating, or the damper position sensor 86 determines that the damper 92 is in a closed, or substantially closed position. The damper 92, when in such a position, substantially retards the velocity of the exhaust gases flowing along the exhaust duct 18 and, in turn, the velocity of the exhaust gases flowing along the discharge passage 22 and the exhaust outlet 14 of the flue 10. Without the temperature probe 84 and/or the damper position sensor 86, the CPU 82 may falsely determine that the flue is partially blocked and unnecessarily actuate the disengageable drive 76.

The disengageable drive 76 may be, for example, a mating pair of electrically powered magnets with one of the pair of electrically powered magnets supported by an adjacent end of the first main shaft 72 and the second one of the pair of electrically powered magnets supported by an adjacent end of the second main shaft 74 whereby the magnetizable surfaces of the magnets are located closely adjacent, but slightly spaced from one another. Due to this arrangement, when the mating pair of electrically powered magnets are supplied with electrical power, via the CPU 82, the mating pair of electrically powered magnets couple the first and second main shafts 72, 74 with one another and, when no power is supplied thereto, the first and second main shafts 72, 74 are able to rotate relative to one another

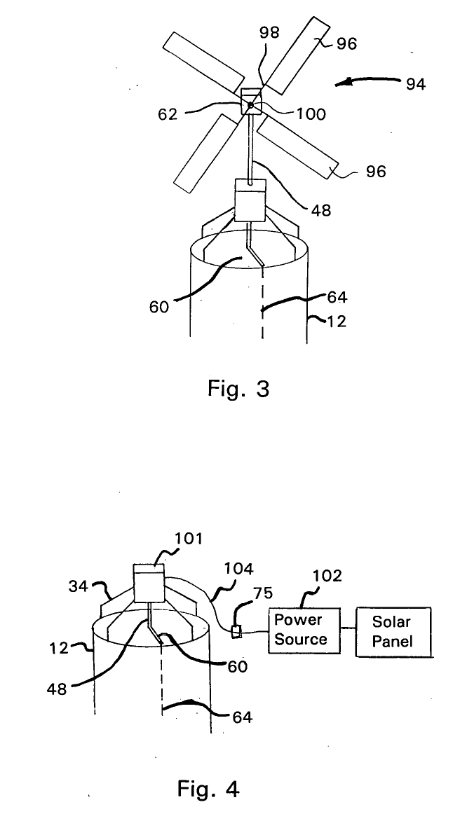

As seen in FIG. 3 as with previous embodiments like reference numerals are utilized for like elements and a detailed discussion will only be provided with respect to the differences between this embodiment of the chimney cleaning apparatus and the others. In this embodiment, rotational motion of the main shaft 48 is supplied by a windmill 94. The windmill 94 comprises a number of blades 96 supported by individual blade support arms 98 which are affixed to or integral with a central rotational shaft 100. In a typical manner, the blades 96 of the windmill 94 are sloped or slightly inclined to cause rotary motion of the central shaft 106 when wind contacts the blades 96. An opposite end of the central shaft 106 of the windmill 94 is coupled to a bevel gear housing (not numbered). The bevel gear of the windmill 94 mates with a bevel gear carried by the second end of the main shaft 48 to cause corresponding rotation of the main shaft 48 and thus the adjustable arm 60 and cable 64, as described above.

With reference now to FIG. 4, a fourth embodiment of the chimney cleaning apparatus will now be described. As this embodiment is quite similar to the second embodiment in many respects, like reference numerals are utilized for like elements and a detailed discussion will only be provided with respect to the differences between the fourth embodiment versus the second embodiment.

According to this embodiment, the bearing housing 42, bracket 50, radial shafts 54 and wind cups 56 are all eliminated in favor of an electrical rotary motor 101 which is drivingly connected to the top most second end of the main shaft 48 to supply drive thereto. The electrical rotary motor 101 is electrically coupled to a remote power source 102 by a power cord 104 and a switch 75 controls operation of the electrical rotary motor 101. An operator can actuate the chimney cleaning apparatus 30, as desired, simply by manipulating the switch 75 to an “on” position and such activation will, in turn, cause the chimney cleaning apparatus 30 to commence rotation and the suspended cable 64 and clean the flue 10. Once the flue 10 is adequately cleaned, the operator manipulates the switch 75 to an “off” or closed position to discontinue operation of the chimney cleaning apparatus 30. Alternatively, the electrical rotary motor 101 may be electrically coupled to the CPU 82 so that the CPU 82 can automatically actuate the electrical rotary motor 101 as necessary, e.g., when the velocity probe 78, temperature probe 84 and/or damper position sensor 86 detect that the flue 10 is at least partially blocked and needs cleaning. The switch 75 may be replace with a timer, or some other conventional device which periodically turns the chimney cleaning apparatus 30 on and/or off as desired or necessary.

It is to be appreciated that the remote power source 102 could alternatively be batteries or any other known source of electrical power. In addition, a solar panel(s) (see FIG. 4) may be located on the roof and coupled directly to the rotary motor 101 to generate electrical power and supply the same to the rotary motor 101 to facilitate operation of the chimney cleaning apparatus 30, as necessary. It is also conceivable that the solar panel(s) may be coupled to the batteries to store the generated electrical in the batteries for use when necessary or desired.

With reference now to FIG. 7, an optional cable end covering is shown. The cable 64, as used in the chimney cleaning apparatus 30, is generally made of a plurality of tightly wound individual wires 41. Over prolonged use of the cable 64, the cable may start to become unraveled or unwound. To counter this unraveling or unwinding of the cable, the free end 45 of the cable 64 can be provided with a tightly snug fitting end cap 43. The end cap 43 is placed over the free end 45 of the cable 64 and may be secured thereto by gluing, soldering, brazing, etc., and is in tight communication with the plurality of wound individual wires 41 thus maintaining the overall integrity of the cable 64 and minimizing unraveling of the same. It should be appreciated that the end cap 43, if desired, can have an outer surface provided with a plurality of brush members 47 attached thereto to facilitate cleaning of the flue 10 of the chimney 2 during operation of the chimney cleaning apparatus 30. The brush members 47 will diminish the force with which the free end 45 of the cable 64 strikes the inwardly facing surface of the chimney liner 12 thus reducing thus the generation of noise during the operation of the chimney cleaning apparatus 30.

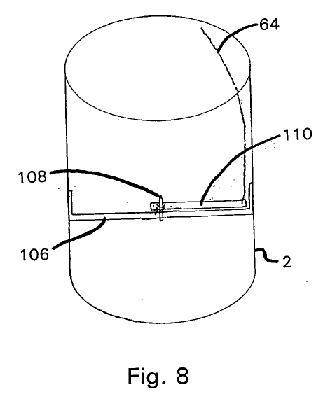

With reference now to FIG. 8, an alternative arrangement for the lower end of the cable 64 is shown. According to this embodiment, a base cross member or some other base support 106 is secured to a lower portion of the flue 10 of the chimney 2. The base support 106 is supported, in a conventional manner, e.g., by bolts, so as to extend across the diameter of the inside surface 55 of the chimney liner 12. A central base support shaft 108 is securely fastened at a midpoint of the base support 106 such that the central base support shaft 108 is substantially coincident with the longitudinal axis A of the chimney 2. A rotatable bar 110 is rotatably supported by the central base support shaft 108 via a bearing (not numbered) to allow the rotatable bar 110 to rotate relative to the base support 106. A remote free end of the rotatable bar 110 is coupled to the lower end of the cable 64, by an eye hook, for example, attached to the free end of the rotatable bar 110. Due to this arrangement, as the lower end of the cable 64 is attached to the rotatable bar 110, the rotatable bar 110 is caused to rotate with the cable 64, as it rotates. Typically there will be ample “slack” in the cable 64, i.e., the cable 64 extending from the extendable arm 60 to the rotatable bar 110 will be loosely supported therebetween, to allow the cable 64 to assume a spiral orientation as it rotates. If desired, the free end of the rotatable bar 110 can be provided with an aperture therein and the free end of the cable 64 is allowed to pass through the aperture in the rotatable bar 110. The end of the cable 64, after passing through the aperture in the rotatable bar 110, can be knotted or otherwise had an enlarged head to prevent the remote end of the cable 64 from again passing through the aperture in the rotatable bar 110 becoming separated therefrom.

As the main shaft 48 rotates, and since the free end of the cable 64 is attached to the rotatable bar 110, the rotatable bar 110 will be induced to rotate. The cable 64 will, as discussed above, be swung and dragged along the inside surface of the flue and tend to knocking off any built up creosote, ash or soot. This arrangement of the cable facilitates maintaining the second end of the cable 64 in close proximity with the inside surface of the flue 10 to enhance cleaning of the lower portion of the flue 10.

It should be noted that the chimney liner 12 preferably has a circular cross section, however a chimney liner with a somewhat rounded square or somewhat rounded rectangular cross section is also possible.

It is to be appreciated that, according to the present invention, the alternatively may be supported on the top surface of the chimney 2 or between inwardly facing surface of the bricks 4 and the outwardly facing surface of the chimney liner 12.

Since certain changes may be made in the various embodiments of the above described chimney cleaning apparatus, without departing from the spirit and scope of the invention herein involved, it is intended that all of the subject matter of the above description or shown in the accompanying drawings shall be interpreted merely as examples illustrating the inventive concept herein and shall not be construed as limiting the invention.

What is claimed is:

1. A chimney cleaning apparatus comprising:
a support structure for attaching the chimney cleaning apparatus adjacent an exhaust outlet of a chimney;
an adjustable rotatable arm supported by the support structure;
a drive mechanism for rotating the adjustable rotatable arm relative to the support structure; and
a cable attached to a free end of the adjustable rotatable arm and the cable, during use, extending into a discharge passage of the chimney to facilitate cleaning of the chimney when the drive mechanism rotates the adjustable rotatable arm.

2. The chimney cleaning apparatus of claim 1, wherein a first end of a main shaft supports the adjustable rotatable arm and the main shaft is rotatably coupled to the support structure by at least one bearing.

3. The chimney cleaning apparatus of claim 2, wherein the main shaft substantially is coincident with a longitudinal axis of the chimney.

4. The chimney cleaning apparatus of claim 1, wherein the drive mechanism comprises a plurality of wind cups coupled to a second end of the main shaft, and rotation of the plurality of wind cups cause rotation of the main shaft, the adjustable rotatable arm, and the cable.

5. The chimney cleaning apparatus of claim 2, wherein the drive mechanism comprises a wind mill coupled to a second end of the main shaft, and rotation of the windmill causes rotation of the main shaft, the adjustable rotatable arm, and the cable.

6. The chimney cleaning apparatus of claim 2, wherein the drive mechanism comprises an electric motor, and the electric motor is coupled to a second end of the main shaft, and rotation of the electric motor causes rotation of the main shaft, the adjustable rotatable arm, and the cable.

7. The chimney cleaning apparatus of claim 6, wherein the electric motor is couple to a power source which supplies electrical power thereto via a power cord and a switch is provided in the power cord to facilitate turning the electrical motor on and off.

8. The chimney cleaning apparatus of claim 6, wherein the electric motor is couple to at least one battery which supplies electrical power thereto via a power cord.

9. The chimney cleaning apparatus of claim 6, wherein the electric motor is couple to at least one battery which supplies electrical power thereto via a power cord and a solar panel is connected to the at least one battery to facilitate charging thereof.

10. The chimney cleaning apparatus of claim 1, wherein the drive mechanism is coupled to the main shaft by a disengageable drive so that the disengageable drive is engaged, the adjustable rotatable arm rotates with the drive mechanism, and when the disengageable drive is disengaged, the drive mechanism is able to rotate relative to adjustable rotatable arm.

11. The chimney cleaning apparatus of claim 1, wherein the drive mechanism is coupled to a central processing unit and the central processing unit controls operation of the drive mechanism.

12. The chimney cleaning apparatus of claim 11, wherein at least one sensor is coupled to the central processing unit to provide an input to the central processing unit and facilitate control of the chimney cleaning apparatus.

13. The chimney cleaning apparatus of claim 12, wherein a velocity probe is positioned adjacent the exhaust outlet of the chimney to measure a velocity of any gas exiting therefrom; a temperature probe is located within an exhaust duct connected to the chimney to measure a temperature of exhaust gasses flowing through the exhaust duct; a damper position sensor is coupled to a damper of the exhaust duct to detect a position of the damper; and the velocity probe, the temperature probe and the damper position sensor are coupled to the central processing unit to provide inputs thereto.

14. The chimney cleaning apparatus of claim 12, wherein a rotatable bar is rotatably supported within the chimney and a remote free end of the rotatable bar is coupled to a lower end of the cable to attach the lower end of the cable to the free end of the rotatable bar.

15. The chimney cleaning apparatus of claim 2, further comprising a cable end cap attached to a free end of the cable.

16. A chimney cleaning apparatus comprising:
a support structure for attaching the chimney cleaning apparatus adjacent an exhaust outlet of a chimney defining a longitudinal axis, and a main shaft is rotatably coupled to the support structure by at least one bearing so that the main shaft is substantially coincident with the longitudinal axis of the chimney;
an adjustable rotatable arm supported by a first end of the main shaft;
an electric motor attached to a second end of the main shaft for rotating the adjustable rotatable arm relative to the support structure; and
a cable attached to a free end of the adjustable rotatable arm and the cable, during use, extending into a discharge passage of the chimney to facilitate cleaning of the chimney when the electric motor rotates the adjustable rotatable arm and the cable.

17. The chimney cleaning apparatus of claim 16, wherein the electric motor is coupled to a central processing unit and the central processing unit controls operation of the electric motor.

18. The chimney cleaning apparatus of claim 17, wherein a velocity probe is positioned adjacent the exhaust outlet of the chimney to measure a velocity of any gas exiting therefrom; a temperature probe is located within an exhaust duct connected to the chimney to measure a temperature of exhaust gasses flowing through the exhaust duct; a damper position sensor is coupled to a damper of the exhaust duct to detect a position of the damper; and the velocity probe, the temperature probe and the damper position sensor are coupled to the central processing unit to provide inputs thereto.

19. The chimney cleaning apparatus of claim 16, further comprising a cable end cap attached to a free end of the cable.

20. A method of cleaning a chimney with a chimney cleaning apparatus, the method comprising the steps of:
attaching, via a support structure, the chimney cleaning apparatus adjacent an exhaust outlet of a chimney defining a longitudinal axis, and rotatably coupling a main shaft to the support structure by at least one bearing so that the main shaft is substantially coincident with the longitudinal axis of the chimney;
supporting an adjustable rotatable arm at a first end of the main shaft;
attaching an electric motor a second end of the main shaft for rotating the adjustable rotatable arm relative to the support structure; and
attaching a free end of a cable to the adjustable rotatable arm and extending the free end of the cable into a discharge passage of the chimney, and cleaning of the chimney as the electric motor rotates the adjustable rotatable arm and cable.
